(19) United States
(12) Patent Application Publication
(10) Pub. No.: US 2015/0205002 A1
(43) Pub. Date: Jul. 23, 2015

(54) Methods for Interpretation of Time-Lapse Borehole Seismic Data for Reservoir Monitoring

(71) Applicant: Schlumberger Technology Corporation, Sugar Land, TX (US)

(72) Inventors: Lin Liang, Cambridge, MA (US); Maokun Li, Belmont, MA (US); Aria Abubakar, Sugar Land, TX (US); Tarek M. Habashy, Burlington, MA (US); Henry Menkiti, Houston, TX (US); Igor Borodin, Katy, TX (US); Les Nutt, Houston, TX (US)

(21) Appl. No.: 14/414,704

(22) PCT Filed: Jul. 25, 2013
(86) PCT No.: PCT/US2013/051937

§ 371 Date: Jan. 14, 2015

Related U.S. Application Data
(60) Provisional application No. 61/675,439, filed on Jul. 25, 2012.

(51) Int. Cl. G01V 99/00; G06F 17/10

(52) U.S. Cl. CPC G01V 99/005; G06F 17/10

(57) ABSTRACT

A method for analyzing a reservoir parameter, the method including obtaining baseline borehole seismic (BHS) measurements and monitor BHS measurements, calculating, by a processor, a baseline velocity model from the baseline BHS measurements, calculating, by the processor, a monitor velocity model from the monitor BHS measurements, and determining a model change in the reservoir parameter by comparing the baseline velocity model and the monitor velocity model.

### CROSS REFERENCE TO RELATED APPLICATIONS

This application claims priority under 35 U.S.C. §119(e) to U.S. Provisional Patent Application No. 61/675,439, filed on Jul. 25, 2012, and entitled “METHODS FOR IMPROVING INTERPRETATION OF TIME-LAPSE BOREHOLE SEISMIC DATA FOR RESERVOIR MONITORING APPLICATIONS,” which is incorporated by reference.

### FIELD OF THE DISCLOSURE

This disclosure relates generally to interpretation of seismic data and more specifically, methods of interpretation of time-lapse borehole seismic data for reservoir monitoring.

### BACKGROUND

Operations, such as geophysical surveying, drilling, logging, well completion, hydraulic fracturing, steam injection, and production, are typically performed to locate and gather valuable subterranean assets, such as valuable fluids or minerals. The subterranean assets are not limited to hydrocarbons such as oil, throughout this document, the terms “oilfield” and “oilfield operation” may be used interchangeably with the terms “field” and “field operation” to refer to a site where any types of valuable fluids or minerals can be found and the activities required to extract them. The terms may also refer to sites where substances are deposited or stored by injecting them into subterranean structures using boreholes and the operations associated with this process. Further, the term “field operation” refers to a field operation associated with a field, including activities related to field planning, wellbore drilling, wellbore completion, and/or production using the wellbore (also referred to as borehole). During such operations, properties of the field may change.

### SUMMARY

In general, in one aspect, the present disclosure relates to a method for analyzing a reservoir parameter, the method including obtaining baseline borehole seismic (BHS) measurements and monitor BHS measurements, calculating, by a processor, a baseline velocity model from the baseline BHS measurements, calculating, by the processor, a monitor velocity model from the monitor BHS measurements, and determining a model change in the reservoir parameter by comparing the baseline velocity model and the monitor velocity model.

In general, in another aspect, the present disclosure relates to a system for analyzing a reservoir parameter, the system including a computer processor, a storage unit configured to store baseline borehole seismic (BHS) measurements and monitor BHS measurements, a velocity builder executable by the computer processor and configured to calculate a baseline velocity model from the baseline BHS measurements, and calculate a monitor velocity model from monitor BHS measurements, and a velocity analyzer executable by the computer processor and configured to determine a model change in the reservoir parameter by comparing the baseline velocity model and the monitor velocity model.

In general, in another aspect, the present disclosure relates to a method for modeling a reservoir, the method including obtaining a first plurality of borehole seismic (BHS) measurements of the reservoir corresponding to a first time, obtaining a second plurality of BHS measurements of the reservoir corresponding to a second time, obtaining a reservoir model, generating, by simulating the reservoir model, a first plurality of reservoir properties corresponding to the first time and a second plurality of reservoir properties corresponding to the second time, calculating a first plurality of BHS simulated values from the first plurality of reservoir properties, calculating a second plurality of BHS simulated values from the second plurality of reservoir properties, executing a first comparison of the first plurality of BHS simulated values and the second plurality of BHS simulated values, executing a second comparison of the baseline BHS measurements and the monitor BHS measurements, calculating a misfit value from the first comparison and second comparison, and updating, in response to the misfit value exceeding a threshold, the reservoir model.

In general, in another aspect, the present disclosure relates to a system for modeling a reservoir, the system including a computer processor; a storage unit configured to store a first plurality of borehole seismic (BHS) measurements of the reservoir corresponding to a first time, a second plurality of BHS measurements of the reservoir corresponding to a second time, and a reservoir model, a simulator executable by the computer processor and configured to generate, by simulating the reservoir model, a first plurality of reservoir properties corresponding to the first time and a second plurality of reservoir properties corresponding to the second time, a modeling engine executable by the computer processor and configured to calculate a first plurality of BHS simulated values from the first plurality of reservoir properties and a second plurality of BHS simulated values from the second plurality of reservoir properties, a comparator executable by the computer processor and configured to execute a first comparison of the first plurality of BHS simulated values and the second plurality of BHS simulated values, execute a second comparison of the first plurality of BHS measurements and the second plurality of BHS measurements, and calculate a misfit value from the first comparison and second comparison, in which, in response to the misfit value exceeding a threshold, the reservoir model is updated by the modeling engine.

In general, in another aspect, the present disclosure relates to a method for producing a well, the method including obtaining baseline borehole seismic (BHS) measurements and monitor BHS measurements, calculating, by a processor, a baseline velocity model from the baseline BHS measurements, calculating, by the processor, a monitor velocity model from the monitor BHS measurements, determining a model change in the reservoir parameter by comparing the baseline velocity model and the monitor velocity model, and changing a production parameter based on the model change.

In general, in another aspect, the present disclosure relates to a non-transitory computer-readable storage medium including a plurality of instructions for analyzing a reservoir parameter, the plurality of instructions including functionality to obtain baseline borehole seismic (BHS) measurements and monitor BHS measurements, calculate a baseline velocity model from the baseline BHS measurements, calculate a monitor velocity model from the monitor BHS measurements, and determine a model change in the reservoir parameter by comparing the baseline velocity model and the monitor velocity model.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects and advantages of the invention will be apparent from the following description and the appended claims.

### BRIEF DESCRIPTION OF DRAWINGS

The appended drawings illustrate several examples of interpretation and are not to be considered limiting of its scope, for interpretation may admit to other equally effective examples.

FIG. 1 is a schematic view of an example wellsite.

FIG. 2 is an example diagram of measuring equipment that may be used to generate and measure signals.

FIG. 3 shows an example of a system with an analysis engine and a storage unit.

FIG. 4 illustrates a flowchart of an example method for analyzing data.

FIG. 5 shows an example of a system with a modeling engine and a storage unit.

FIG. 6 illustrates a flowchart of an example method for analyzing data.

FIG. 7 is schematic view of an example wellsite depicting a well operation communicating with a system.

FIG. 8 shows an example computer system.

### DETAILED DESCRIPTION

Specific examples will now be described in detail with reference to the accompanying figures. Like elements in the various figures are denoted by like reference numerals for consistency.

In the following detailed description, numerous specific details are set forth in order to provide a more thorough understanding. However, it will be apparent to one of ordinary skill in the art that the disclosed subject matter of the application may be practiced without these specific details. In other instances, well-known features have not been described in detail to avoid unnecessarily complicating the description.

A wellsite may include a drilling rig for drilling a borehole along with various tools and operations gear and personnel to make up and operate the well. During a recovery process, such as, but not limited to, waterflood, steamflood, or CO₂ injection, hydrocarbons (e.g., oil and/or gas) may be extracted from a reservoir.

At any time during well operation, and in particular during the recovery process, it may be advantageous for engineers to have the ability to monitor the reservoir or a formation surrounding the reservoir or borehole. Monitoring may involve the monitoring of time sensitive reservoir or formation properties including, but not limited to, saturation, pressure, temperature, and density. Monitoring may help engineers make complex decisions regarding the operation and stability of the reservoir and ultimately, the production of the well.

In order to monitor the reservoir, data may be acquired at different times throughout operation. Particularly, seismic data may be acquired, e.g., borehole seismic (BHS) measurements. BHS measurements may include measurements such as vertical seismic profile (VSP) measurements and/or crosswell seismic measurements. As understood by one having ordinary skill, the data acquired may not be limited to only seismic data, as electromagnetic data, among other types of data, may be acquired and used to monitor the reservoir.

BHS surveys can be used to complement other types of surveys, e.g., surface seismic surveys and/or electromagnetic surveys. BHS surveys may deploy receivers or both sources and receivers in the borehole. Providing receivers or both sources and receivers down hole limits the amount of noise interference that would otherwise be caused by receivers being provided along the surface, as done in surface seismic, for example. Additionally, in BHS surveys, the location of the receivers and/or sources may be placed in relatively fixed positions, such as by using permanent in-well devices or sensors that include receivers and/or sources.

Compared to surface seismic, VSP is capable of providing images (images of a geologic formation or reservoir, in particular, the Earth's subsurface surrounding the borehole) with higher resolution due to acquisition geometry, among other reasons. For example, as discussed above, VSP is capable of deploying receivers in a low noise environment. Further, VSP is able to provide a more well-defined and accurate image in regions such as subsalt and shallow gas, where surface seismic may otherwise be less accurate due to environment constraints. Moreover, crosswell seismic may be capable of providing images of even higher resolution compared to those provided by VSP because crosswell seismic operates and acquires data at a higher frequency allowing for less noise.

VSP measurements are because of the capability to detect direct down going signals, which helps to distinguish multiples (noise whose reflection energy includes multiple energy characteristics of a single reflector) from primary arrivals (signal including the first, or primary, energy characteristics of a reflector) during data analysis and processing. This enables a more reliable processing of the surface seismic upgoing wavefield. In VSP, both receiver depth and travel time to the receiver can accurately be acquired. Therefore, VSP may be used to tie different types of data (in this case, VSP measurements and surface seismic measurements) together. Advantageously, the tying of different data allows for a more accurate, well defined, and reliable set of data which may be used to determine a model of the reservoir.

As discussed above, data may be acquired at different times throughout the recovery process, e.g., at an initial time and at a later time. Data acquired at different times may then be compared for the purpose of identifying and/or determining any changes to reservoir properties such as saturation, pressure, temperature, and density, among others. To determine these changes, however, it is advantageous to acquire data at different times in which the acquisition geometry is repeatable (i.e., the location and layout of the receivers and sources used to acquire the data are the same, or approximately the same, when acquiring the data at different times) and in which the processing of the acquired data is repeatable (i.e., the process that raw data undergoes after acquisition is the same, or approximately the same, when acquiring the data at different times).

When acquisition and data processing is repeatable, the reservoir may be monitored by observing and identifying the changes in the subsurface (region surrounding the borehole) by comparing subsurface images generated at the initial time (baseline) and subsurface images generated at the later time (monitor). Changes in the subsurface may be used to determine changes in reservoir properties. Knowing the reservoir properties and their changes will help provide engineers with an accurate representation and/or model of the reservoir. The reservoir model and/or the reservoir properties may be used by engineers during geosteering, extraction, or production of the well, among other operations. For example, engineers may use this information to make decisions about the production viability of the well, the stability of the well, and/or future production of the well, among other things.

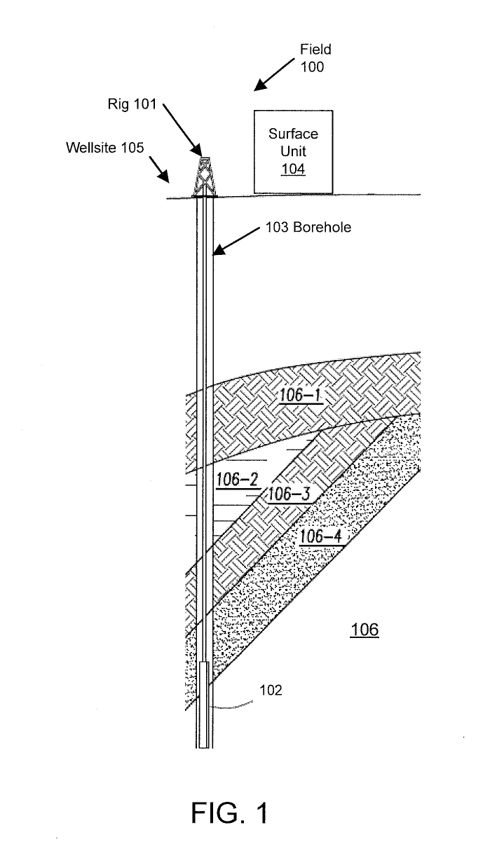

FIG. 1 depicts a schematic view, partially in cross section, of a field 100 in which BHS may be used. The reservoir 106 includes several geological structures. As shown, the reservoir has a sandstone layer 106-1, a limestone layer 106-2, a shale layer 106-3, and a sand layer 106-4. In one or more examples, various survey tools and/or data acquisition tools are adapted to measure the reservoir and detect the characteristics of the geological structures of the reservoir.

As shown in the example of FIG. 1, the wellsite 105 includes a rig 101, a borehole 103, and other wellsite equipment and is configured to perform wellbore operations, such as logging, drilling, fracturing, production, or other applicable operations. Generally, these operations performed at the wellsite 105 are referred to as field operations of the field 100. These field operations may be performed as directed by the surface unit 104.

Field operations (e.g., logging, drilling, fracturing, injection, production, or other applicable operations) may be performed according to a field operation plan that is established prior to the field operations. The field operation plan may set forth equipment, pressures, trajectories and/or other parameters that define the operations performed for the wellsite. The field operation may then be performed according to the field operation plan. However, as information is gathered, the field operation may deviate from the field operation plan. Additionally, as drilling, fracturing, injection, EOR, or other operations are performed, the subsurface conditions may change. A reservoir model may also be adjusted as new information is collected.

In one example, the surface unit 104 is operatively coupled to the measuring equipment 102. The surface unit 104 may be located at the wellsite 105 (as shown) or remote locations. The surface unit 104 may be provided with computer facilities for receiving, storing, processing, and/or analyzing data from data acquisition tools (e.g., measuring equipment 102) disposed in the borehole 103, or other part of the field 100. In one example, the measuring equipment 102 may be installed permanently within the well or with a wireline in the borehole 103. In other examples, the measuring equipment may be coupled to casing, a coiled tubing, a slickline, or a monocable. The measuring equipment may be electromechanical, optical, or a distributed acoustic measurement device along a fiber optic cable, or a combination of these. Other examples of measurement equipment are known in the art.

The surface unit 104 may also be provided with functionality for actuating mechanisms in the field 100. The surface unit 104 may then send command signals to these actuating mechanisms of the field 100 in response to data received, for example to control and/or optimize various field operations described above, including for example drilling, geosteering, extraction, or any other field operations known in the art.

As noted above, the surface unit 104 may be configured to communicate with data acquisition tools (e.g., measuring equipment 102) disposed throughout the field 100 and to receive data therefrom. In one or more examples, the data received by the surface unit 104 may represent characteristics of the reservoir 106 and the borehole 103 (and the region/formation surrounding the borehole) and may include information related to porosity, saturation, permeability, stress magnitude and orientations, elastic properties, thermal properties, etc. These characteristics of the reservoir 106 and the borehole 103 are generally referred to as reservoir or borehole properties that are dependent on the type of rock material in various layers 106-1 through 106-4 of the reservoir 106; as well as the type of fluid within the borehole 103 and mechanical structures associated with the borehole 103. In one or more examples, the data may be received by the surface unit 104 during a drilling, fracturing, logging, injection, or production operation of the borehole 103 to infer properties and make decisions about drilling and production operations.

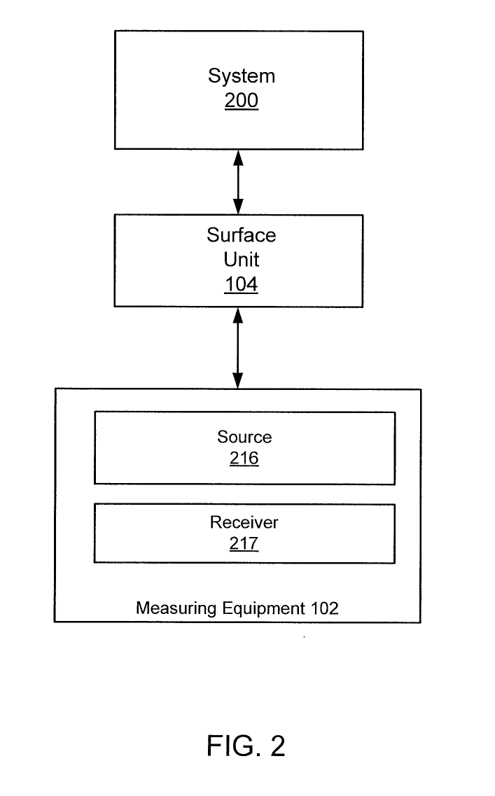

FIG. 2 depicts a diagram of example measuring equipment 102, surface unit 104, and a system 200. As shown in this example, the measuring equipment 102 includes at least one source 216 and at least one receiver 217. As mentioned above, the measuring equipment may only include one or plurality of sources and/or one or plurality of receivers.

The source 216 may include one or a plurality of electromagnetic sources, acoustic sources, or any other sources known in the art. Similarly, the receiver 217 may receive electromagnetic signals, acoustic signals, or any other signals known in the art. For example, the signal generated by the source 216 may be an acoustic signal that may propagate into the surrounding region and the propagated signals may be eventually detected and measured by the receiver 217.

The signals received by the receiver 217 may be used to determine (directly or indirectly through data processing) a variety of properties of the borehole and surrounding formations (e.g., the reservoir). For example, properties such as porosity, resistivity, pressure, and velocity may be determined. One skilled in the art would know and appreciate that the measurements obtained are not limited to the determination of the aforementioned properties as the measurements may be used to determine or infer many other properties known in the art.

The measuring equipment 102 may be communicatively connected to surface unit 104. Although not shown, in the alternative or in addition, the measuring equipment 102 may be communicatively connected to system 200. Moreover, any one of the measuring equipment 102, the surface unit 104, and the system 200 may include a storage unit (not shown) in order to store data acquired by the measuring equipment 102.

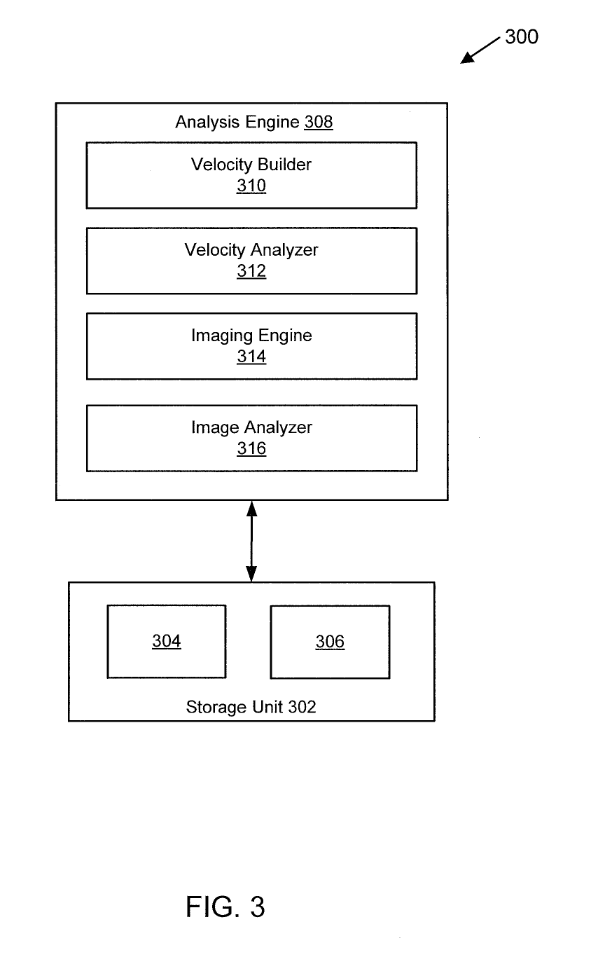

FIG. 3 shows an example system 300 that includes a storage unit 302 capable of storing data. For example, and as illustrated, the storage unit 302 may include baseline BHS data 304 and monitor BHS data 306. The storage unit 302 may be operatively connected to an analysis engine 308. The analysis engine 308 may include a velocity builder 310, a velocity analyzer 312, an imaging engine 314, and an image analyzer 316, as shown. In addition or in the alternative, the analysis engine 308 may include the storage unit 302 or may be separate from at least one of the velocity builder 310, the velocity analyzer 312, the imaging engine 314, and the image analyzer 316.

The system 300 may be configured to determine changes in the formation surrounding the borehole or the reservoir. In particular, the system 300 may be configured to analyze data (e.g., seismic data or electromagnetic data, but not limited to) in order to determine reservoir properties and/or the changing of reservoir properties over a period of time. The reservoir properties may then be analyzed before, during, or after well operations to determine the reservoir viability and/or long term stability, among other things.

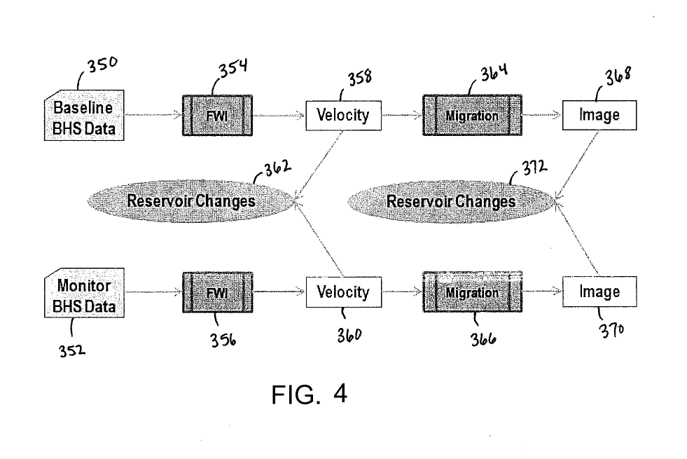

FIG. 4 depicts a flowchart illustrating an example of a method that may be performed by the system 300 as illustrated in FIG. 3. In FIG. 4, the baseline BHS data 350 and monitor BHS data 352 may be stored on storage unit 302 (See FIG. 3, elements 304 and 306). In one or more examples, the baseline BHS data 350 and monitor BHS data 352 may be acquired at separate times and the baseline BHS data 350 and monitor BHS data 352 may be processed separately, as shown.

In addition, the baseline BHS data 350 and monitor BHS data 352 may include data acquired by measuring equipment 102, as illustrated in FIGS. 1 and 2. Additionally, the baseline BHS data 350 and monitor BHS data 352 may include other data or measurements, such as survey geometry, well-logs, and/or pre-processed (or traditionally processed) data, for example. One of ordinary skill in the art would know and appreciate that the baseline and monitor BHS data may not be limited to the aforementioned data types or measurements.

Using the BHS data, the velocity builder 310 may be configured to compute a velocity model for at least one of the baseline BHS data 350 and monitor BHS data 352. For example, and as shown, a full waveform inversion (FWI) method (354 and 356) may be used to derive a baseline velocity model 358 and a monitor velocity model 360. The baseline FWI method 354 and the monitor FWI method 356 may include pre-conditioning of the data. In particular, the baseline BHS data 350 and monitor BHS data 352 may undergo data transformation and/or calibration prior to the calculation of the velocity model(s) using the FWI method. Additionally, parameters used in the baseline FWI method 354 and the monitor FWI method 356 may be adjusted in order to improve respective velocity models 358 and 360. As such, though the FWI algorithm may remain substantially the same for both the baseline BHS data 350 and the monitor BHS data 352, parameters may be adjusted separately in each FWI method (354 and 356) to obtain a more accurate velocity model. Although not shown, the baseline velocity model 358 and/or the monitor velocity model 360 may be stored on storage unit 302.

In addition, or in the alternative, the velocity builder 310 may implement an algorithm or method other than FWI and thus, may result in calculating a model or parameter related to formation properties other than velocity. For example, the velocity model builder 310 may be configured to generate or compute an impedance model. One of ordinary skill in the art would know and appreciate that the models generated by the velocity builder 310 may not be limited to the above examples of velocity and impedance, as the velocity builder 310 may generate other model related to any reservoir parameter known in the art.

As shown, the baseline velocity model 358 and the monitor velocity model 360 resulting from the baseline FWI 354 and the monitor FWI 356, respectively, may be compared to one another in order to determine reservoir changes 362. Here, comparison of the baseline velocity model 358 and the monitor velocity model 360 may be used to determine a change in one or more reservoir properties or one or more formation properties.

In one or more examples, a migration may be performed using the baseline and monitor data. Particularly, the baseline BHS data 350 and the baseline velocity model 358 may be used in a baseline migration 364 to generate a baseline image 368. The baseline migration 364 may include an algorithm that uses measured data (e.g., BHS data 350) along with model data (e.g., velocity model 358) to compute an image 368 that is representative of the measured and modeled data.

Migrations may be computed based on time or depth and may generate results that are based on time or depth. Using measured and modeled data, migrating may be used to “swing” energy in measured data from a location in time (or depth) to a more accurate location in time (or depth) based on the characteristics of the measured data and the modeled data. Here, energy refers to the measured signal(s) that may be received by a receiver (e.g., receiver 217 in FIG. 2) that contains reflected source energy from a reflector in a geologic formation or reservoir.

Similarly to the above baseline migration, the monitor BHS data 352 and the monitor velocity model 360 may be used in a monitor migration 366 to generate a monitor image 370. The monitor migration 366 may include an algorithm that uses measured data (e.g., BHS data 352) along with model data (e.g., velocity model 360) to compute an image 370 that is representative of the measured and modeled data. The monitor image 370 and the baseline image 368 may then be compared to determine reservoir changes 372. Although not shown, the baseline image 368 and/or the monitor image 370 may be stored on storage unit 302.

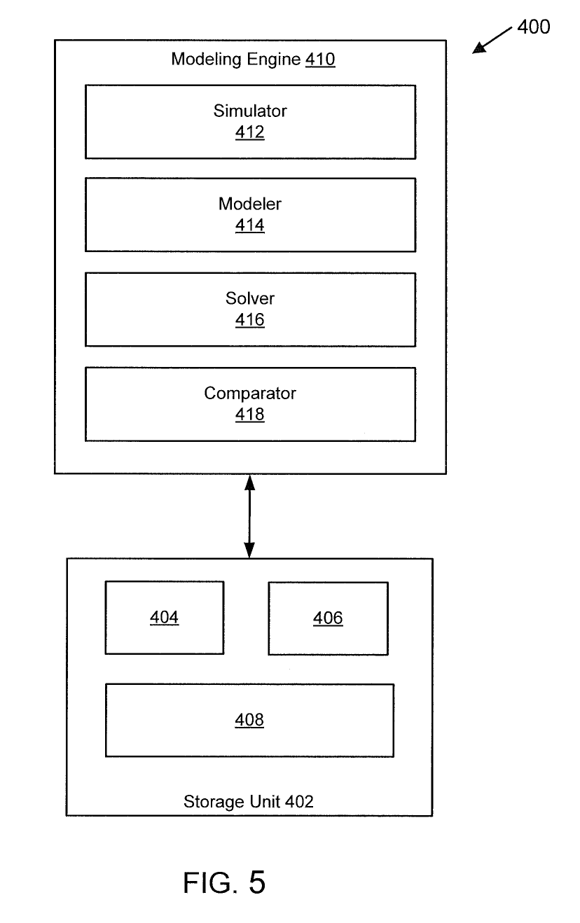

FIG. 5 shows an example system 400 that includes a storage unit 402 capable of storing data. For example, and as illustrated, the storage unit 402 may include baseline BHS data 404 and monitor BHS data 406. The storage unit 402 may also store an initial reservoir model 408. In addition or in the alternative, the storage unit 402 may store time-lapse BHS data and/or production data.

The storage unit 402 may be operatively connected to a modeling engine 410. The modeling engine 410 may include a simulator 412, a modeler 414, a solver 416, and a comparator 418, as shown. In addition or in the alternative, the modeling engine may include the storage unit 402 or may be separate from at least one of the simulator 412, the modeler 414, the solver 416, and the comparator 418.

In one example, the system 400 may be configured to determine changes in the formation surrounding the borehole or the reservoir. In particular, the system 400 may be configured to analyze and simulate data (e.g., seismic data or electromagnetic data) in order to determine reservoir properties and/or the changing of reservoir properties over a period of time. The reservoir properties may then be analyzed before, during, or after well operations, for example, to determine the reservoir viability and/or long term stability, among others. Further, the system 400 may be configured to compare production data to simulated data and/or may be configured to compare or update a reservoir model.

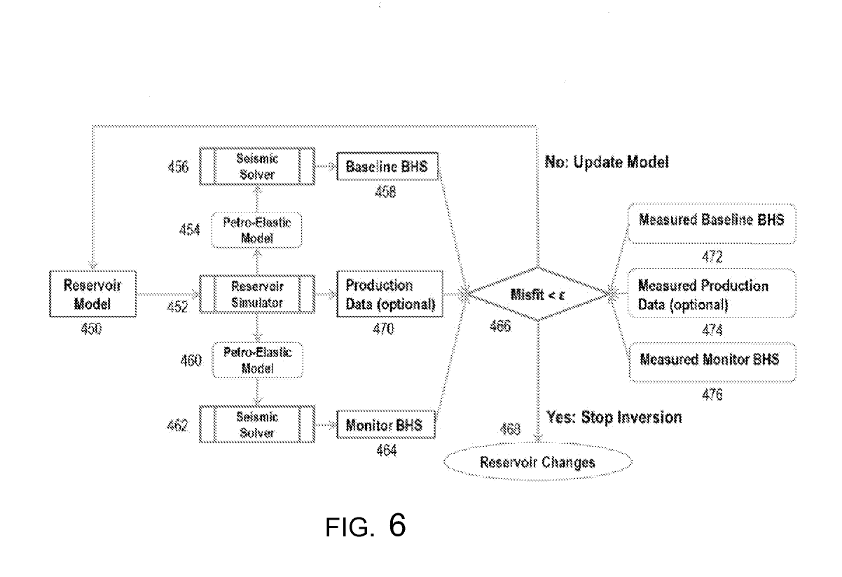

FIG. 6 depicts a flowchart illustrating an example of a method of using time lapse data that may be used with the system 400 in FIG. 5. As shown in FIG. 6, a reservoir model 450 may be determined based on initial acquired data (e.g., from previously obtained data, previous knowledge of the formation or reservoir, and/or determined from processed or modeled data, for example, from the baseline BHS data 350 and monitor BHS data 352, as shown in FIG. 3B).

Additionally, the reservoir model 450 may be based on other data or measurements, such as survey geometry, well-logs, and/or pre-processed (or traditionally processed) data, for example. Furthermore, the reservoir model may be built from other sources (e.g., well-logging and/or historical data, such as injection data) and/or initial guesses of unknown parameters. The system 400 may later solve the unknown parameters to ultimately generate a refined reservoir model. One of ordinary skill in the art would know and appreciate that the baseline and monitor BHS data may not be limited to the aforementioned data or measurements.

In one example, the reservoir model 450 may undergo reservoir simulation 452 using a simulator 412. Here, the simulator 412, simulates the reservoir during one or a plurality of well operations (e.g., extraction/recovery), and determines a first plurality of reservoir properties corresponding to a first time (baseline) and determines a second plurality of reservoir properties corresponding to a second time (monitor). As shown, the first and second pluralities of reservoir properties may be simulated and/or processed separately.

In one example, a first plurality of seismic properties may be determined by the modeler 414 by transforming the first plurality of reservoir properties with rock properties using a petro-elastic model 454. For example, the reservoir simulator 452 may generate a temporal and/or spatial distribution of fluid properties, including, but not limited to, saturation, pore pressure, temperature, and density.

Along with rock properties, the modeler 414 may transform the temporal and/or spatial distribution of fluid properties (first plurality of reservoir properties) to obtain seismic properties such as velocity or impedance using a petro-elastic model 454. In one example, the petro-elastic model 454 may be determined based on survey area and/or type of recovery process.

As indicated by 456, simulated baseline BHS values 458 may be calculated by operating a solver 416 on the first plurality of seismic properties and solving a plurality of wave equations. The comparator 418 may be used to compare the simulated baseline BHS values 458 and previously or continuously acquired baseline BHS measurements. In one or more examples, the modeling engine 410 may update the reservoir model 450 if the result (misfit result/value) of the comparison 466 is greater than a threshold ε. If the comparison 466 yields a result (misfit result/value) that is less than the threshold ε, the reservoir model may then be analyzed to determined reservoir and/or formation parameters along with their changes.

In one example, the second plurality of seismic properties may be determined by the modeler 414 by transforming the second plurality of reservoir properties with rock properties using a petro-elastic model 460. For example, the reservoir simulator 452 may generate a temporal and/or spatial distribution of fluid properties, including, but not limited to, saturation, pore pressure, temperature, and density.

Along with rock properties, the modeler 414 may transform the temporal and/or spatial distribution of fluid properties (second plurality of reservoir properties) to obtain seismic properties such as velocity or impedance using a petro-elastic model 460. In one examples, the petro-elastic model 460 may be determined based on survey area and/or type of recovery process.

As indicated by 462, simulated monitor BHS values 464 may be calculated by operating a solver 416 on the second plurality of seismic properties and solving a plurality of wave equations. The comparator 418 may be used to compare the simulated monitor BHS values 464 and previously or continuously acquired monitor BHS measurements. In one example, the modeling engine 410 may update the reservoir model 450 if the result (misfit result/value) of the comparison 466 is greater than a threshold ε, as shown. If the comparison 466 yields a result (misfit result/value) that is less than the threshold ε, the reservoir model may then be analyzed to determine reservoir and/or formation parameters along with their changes.

The comparison between simulated baseline BHS 458 and measured baseline BHS 472 and between simulated monitor BHS and measured monitor BHS can also be performed simultaneously. The modeling engine 410 may update the reservoir model 450 if the result (misfit result/value) of the comparison 466 is greater than a threshold ε, as shown. If the comparison 466 yields a result (misfit result/value) that is less than the threshold ε, the reservoir model may then be analyzed to determine reservoir and/or formation parameters along with their changes

In addition, if the measured production data 474 is available, simulated production data 470 may also be included in the comparison 466. In one or more embodiments, the simulated baseline BHS values 458 and the simulated monitor BHS values 464 (or the differences between 458 and 464) may be matched or compared to the measured baseline BHS data 472 and the measured monitor BHS data 476 (or the differences between 472 and 476) while the simulated production data 470 is matched or compared to the measured production data. Similar to the above, a comparison 466 may be a combination of comparisons and may determine a result (misfit result/value). In one or more embodiments, the modeling engine 410 may update the reservoir model 450 if the result (misfit result/value) of the comparison 466 is greater than a threshold ε, as shown. If the comparison 466 yields a result (misfit result/value) that is less than the threshold ε, the reservoir model may then be analyzed to determine reservoir and/or formation parameters along with their changes.

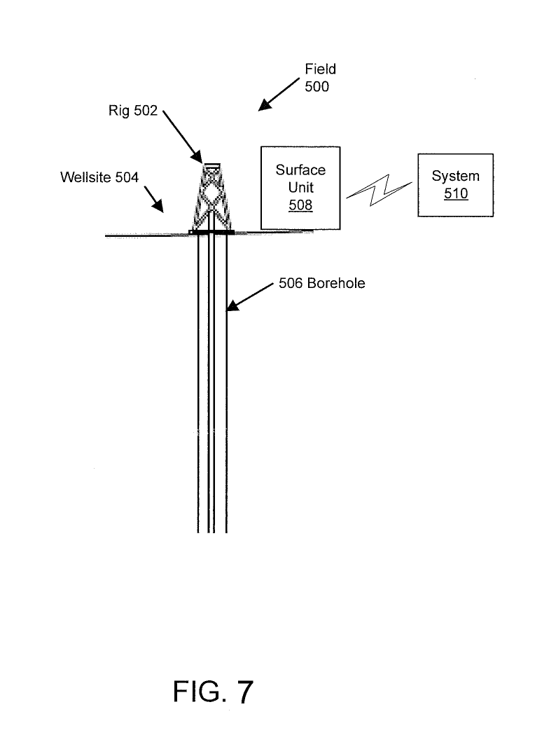

FIG. 7 depicts a schematic view, partially in cross section, of a field 500 in which a system may be deployed. As shown, the wellsite 504 includes a rig 502, a borehole 506, and other wellsite equipment and is configured to perform wellbore operations, such as logging, drilling, fracturing, production, or other applicable operations. These field operations may be performed as directed by the surface unit 508. Further, a system 510 in accordance with one or more examples of the present disclosure may be used in addition or in the alternative to surface unit 508. As shown, surface unit 508 is communicatively connected to system 510.

Field operations (e.g., logging, drilling, fracturing, injection, production, or other applicable operations) may be performed according to a field operation plan that is established prior to the field operations. The field operation plan may set forth equipment, pressures, trajectories and/or other parameters that define the operations performed for the wellsite 504. The field operation may then be performed according to the field operation plan. However, as information is gathered (e.g., from the system 510), the field operation may deviate from the field operation plan. Additionally, as drilling, fracturing, injection, EOR, or other operations are performed, the subsurface conditions may change.

In one example, the surface unit 508 is operatively coupled to the wellsite 504. In one or more examples, surface unit 508 may be located at the wellsite 504 and/or remote locations. The surface unit 508 may be provided with computer facilities for receiving, storing, processing, and/or analyzing data. The surface unit 508 may also be provided with functionality for actuating mechanisms at the field 500. The surface unit 508 may then send command signals to these actuating mechanisms of the field 508 in response to data received, for example to control and/or optimize various field operations described above, including for example drilling, geosteering, extraction, or any other field operation known in the art.

As discussed above, the system 510 may include the functionality to determine changes in reservoir parameters, formation parameters, and/or reservoir models. The determination of such may also be adjusted as new data is collected. As shown, the surface unit 508 is configured to communicate with the system 510. In one or more examples, the data received by the surface unit 508 represents characteristics of the reservoir and/or the formation surrounding the borehole 506 and may include information related to porosity, saturation, permeability, stress magnitude and orientations, elastic properties, thermal properties, etc. In one or more examples, the data may be received by the surface unit 508 from the system 510 during a drilling, fracturing, logging, injection, or production operation of the borehole 506 to infer properties and make decisions about drilling and production operations.

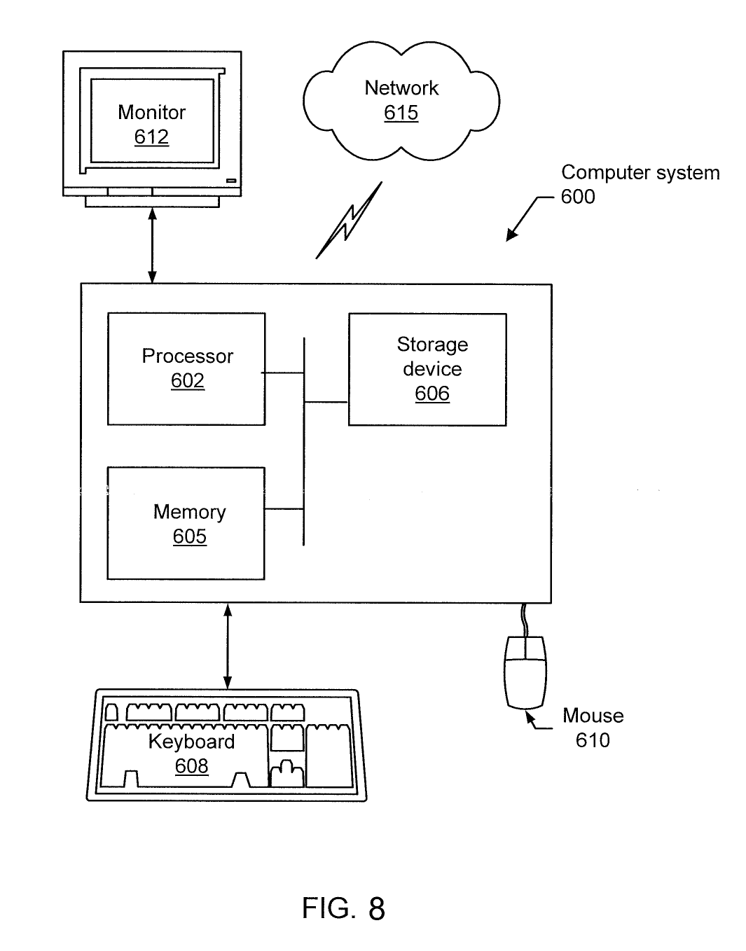

Examples of interpretation as disclosed herein may be implemented on virtually any type of computer regardless of the platform being used. For instance, as shown in FIG. 8, a computer system (600) includes one or more processor(s) (602) such as a central processing unit (CPU) or other hardware processor, associated memory (605) (e.g., random access memory (RAM), cache memory, flash memory, etc.), a storage device (606) (e.g., a hard disk, an optical drive such as a compact disk drive or digital video disk (DVD) drive, a flash memory stick, etc.), and numerous other elements and functionalities typical of today's computers (not shown). The computer (600) may also include input means, such as a keyboard (608), a mouse (610), or a microphone (not shown). Further, the computer (600) may include output means, such as a monitor (612) (e.g., a liquid crystal display LCD, a plasma display, or cathode ray tube (CRT) monitor). The computer system (600) may be connected to a network (615) (e.g., a local area network (LAN), a wide area network (WAN) such as the Internet, or any other similar type of network) via a network interface connection (not shown). Those skilled in the art will appreciate that many different types of computer systems exist (e.g., workstation, desktop computer, a laptop computer, a personal media device, a mobile device, such as a cell phone or personal digital assistant, or any other computing system capable of executing computer readable instructions), and the aforementioned input and output means may take other forms, now known or later developed. Generally speaking, the computer system (600) includes at least the minimal processing, input, and/or output means necessary to practice one or more examples.

Further, those skilled in the art will appreciate that one or more elements of the aforementioned computer system (600) may be located at a remote location and connected to the other elements over a network. Additionally, one or more examples may be implemented on a distributed system having a plurality of nodes, where each portion of the implementation may be located on a different node within the distributed system. In one or more examples, the node corresponds to a computer system. Alternatively, the node may correspond to a processor with associated physical memory. The node may alternatively correspond to a processor with shared memory and/or resources. Further, software instructions to perform one or more examples may be stored on a computer readable medium such as a compact disc (CD), a diskette, a tape, or any other computer readable storage device.

As discussed above, examples disclosed herein relate to a method for analyzing a reservoir parameter, the method including obtaining baseline borehole seismic (BHS) measurements and monitor BHS measurements, calculating, by a processor, a baseline velocity model from the baseline BHS measurements, calculating, by the processor, a monitor velocity model from the monitor BHS measurements, and determining a model change in the reservoir parameter by comparing the baseline velocity model and the monitor velocity model. Examples disclosed herein may also include calculating at least one selected from a group of the baseline velocity model and the monitor velocity model using a full waveform inversion method.

Other examples disclosed herein may include calculating, by the processor, a baseline image by performing a baseline migration using the baseline seismic data and the baseline velocity model, calculating, by the processor, a monitor image by performing a baseline migration using the baseline seismic data and the baseline velocity model, and determining an image change in the reservoir parameter by comparing the baseline image and the monitor image. Examples disclosed herein may also include the baseline migration and the monitor migration including at least one selected from a group of a time migration and a depth migration. Further, examples disclosed herein may also include updating a reservoir model based on at least one selected from a group of the model change and the image change.

Additionally, other examples disclosed herein may include generating, by simulating the reservoir model, a first plurality of reservoir properties corresponding to a first time and a second plurality of reservoir properties corresponding to a second time, calculating a first plurality of BHS simulated values from the first plurality of reservoir properties, calculating a second plurality of BHS simulated values from the second plurality of reservoir properties, executing a first comparison of the first plurality of BHS simulated values and the second plurality of BHS simulated values, executing a second comparison of the first plurality of BHS measurements and the second plurality of BHS measurements, calculating a misfit value from the first comparison and second comparison, and updating, in response to the misfit value exceeding a threshold, the reservoir model.

Other examples may include the reservoir parameter including at least one selected from a group consisting of saturation, pore pressure, compaction, density, temperature, fluid movement, heat front, and porosity. Examples disclosed herein may also include at least one of the baseline seismic measurements and the monitor seismic measurements including at least one selected from a group of vertical seismic profile measurements and crosswell seismic measurements.

As discussed above, examples disclosed herein relate to a system for analyzing a reservoir parameter, the system including a computer processor, a storage unit configured to store baseline borehole seismic (BHS) measurements and monitor BHS measurements, a velocity builder executable by the computer processor and configured to calculate a baseline velocity model from the baseline BHS measurements, and calculate a monitor velocity model from monitor BHS measurements, and a velocity analyzer executable by the computer processor and configured to determine a model change in the reservoir parameter by comparing the baseline velocity model and the monitor velocity model. Examples disclosed herein may also include the velocity builder configured to calculate at least one selected from a group of the baseline velocity model and the monitor velocity model by performing a full waveform inversion method.

Other examples disclosed herein may also include an imaging engine executable by the computer processor and configured to calculate a baseline image from the baseline velocity model, calculate a monitor image from the monitor velocity model, and an image analyzer executable by the computer processor and configured to determine an image change in the reservoir parameter by comparing the baseline image and the monitor image. Examples disclosed herein may also include the imaging engine configured to at least one of calculate the baseline image by performing a baseline migration using the baseline seismic data and the baseline velocity model, and calculate the monitor image by performing a monitor migration using the monitor seismic data and the monitor velocity model, in which the baseline migrations and the monitor migration include at least one selected from a group of a time migration and a depth migration.

Further, examples herein may include an analysis engine configured to update a reservoir model based on at least one selected from a group consisting of the model change and the image change. Examples disclosed herein may also include the reservoir parameter including at least one selected from a group consisting of saturation, pore pressure, compaction, density, temperature, fluid movement, heat front, and porosity.

Additionally, examples disclosed herein may include at least one of the baseline BHS measurements and the monitor BHS measurements including at least one selected from a group of vertical seismic profile measurements and crosswell seismic measurements.

As discussed above, examples disclosed herein relate to a method for modeling a reservoir, the method including obtaining a first plurality of borehole seismic (BHS) measurements of the reservoir corresponding to a first time, obtaining a second plurality of BHS measurements of the reservoir corresponding to a second time, obtaining a reservoir model, generating, by simulating the reservoir model, a first plurality of reservoir properties corresponding to the first time and a second plurality of reservoir properties corresponding to the second time, calculating a first plurality of BHS simulated values from the first plurality of reservoir properties, calculating a second plurality of BHS simulated values from the second plurality of reservoir properties, executing a first comparison of the first plurality of BHS simulated values and the second plurality of BHS simulated values, executing a second comparison of the baseline BHS measurements and the monitor BHS measurements, calculating a misfit value from the first comparison and second comparison, and updating, in response to the misfit value exceeding a threshold, the reservoir model.

Other examples herein may include generating the first plurality of BHS simulated values including: generating a plurality of seismic properties by transforming the first plurality of reservoir properties using a petro-elastic model, and operating a seismic solver on the plurality of seismic properties, in which operating the seismic solver comprises solving a wave equation, and in which the plurality of seismic properties comprises at least one selected from a group consisting of velocity and impedance.

As discussed above, examples disclosed herein relate to a system for modeling a reservoir, the system including a computer processor; a storage unit configured to store a first plurality of borehole seismic (BHS) measurements of the reservoir corresponding to a first time, a second plurality of BHS measurements of the reservoir corresponding to a second time, and a reservoir model, a simulator executable by the computer processor and configured to generate, by simulating the reservoir model, a first plurality of reservoir properties corresponding to the first time and a second plurality of reservoir properties corresponding to the second time, a modeling engine executable by the computer processor and configured to calculate a first plurality of BHS simulated values from the first plurality of reservoir properties and a second plurality of BHS simulated values from the second plurality of reservoir properties, a comparator executable by the computer processor and configured to execute a first comparison of the first plurality of BHS simulated values and the second plurality of BHS simulated values, execute a second comparison of the first plurality of BHS measurements and the second plurality of BHS measurements, and calculate a misfit value from the first comparison and second comparison, in which, in response to the misfit value exceeding a threshold, the reservoir model is updated by the modeling engine.

Other examples disclosed herein may include a modeler executable by the computer processor and configured to generate a plurality of seismic properties by transforming the first plurality of reservoir properties using a petro-elastic model, and a seismic solver executable by the computer processor and configured to generate the first plurality of BHS simulated values using the first plurality of seismic properties, in which the seismic solver is further configured to generate the first plurality of BHS simulated values by solving a wave equation using the first plurality of seismic properties. Examples disclose herein may also include the plurality of seismic properties including at least one selected from a group of velocity and impedance.

As discussed above, examples disclosed herein relate to a method for producing a well, the method including obtaining baseline borehole seismic (BHS) measurements and monitor BHS measurements, calculating, by a processor, a baseline velocity model from the baseline BHS measurements, calculating, by the processor, a monitor velocity model from the monitor BHS measurements, determining a model change in the reservoir parameter by comparing the baseline velocity model and the monitor velocity model, and changing a production parameter based on the model change.

Other examples disclosed herein may include at least one selected from a group of the baseline velocity model and the monitor velocity model is calculated using a full waveform inversion method.

Further, examples disclosed herein may also include calculating, by the processor, a baseline image by performing a baseline migration using the baseline seismic data and the baseline velocity model, calculating, by the processor, a monitor image by performing a baseline migration using the baseline seismic data and the baseline velocity model, determining an image change in the reservoir parameter by comparing the baseline image and the monitor image, and changing a production parameter based on the image change, in which the baseline migration and the monitor migration include at least one selected from a group consisting of a time migration and a depth migration.

Additionally, examples disclosed herein may include updating a reservoir model based on at least one selected from a group of the model change and the image change, and changing the production parameter based on the reservoir model.

Examples disclosed herein may also include generating, by simulating the reservoir model, a first plurality of reservoir properties corresponding to a first time and a second plurality of reservoir properties corresponding to a second time, calculating a first plurality of BHS simulated values from the first plurality of reservoir properties, calculating a second plurality of BHS simulated values from the second plurality of reservoir properties, executing a first comparison of the baseline plurality of BHS simulated values and the second plurality of BHS simulated values, executing a second comparison of the baseline BHS measurements and the monitor BHS measurements, calculating a misfit value from the first comparison and second comparison, updating, in response to the misfit value exceeding a threshold, the reservoir model, and changing the production parameter based on the updated reservoir model.

Other examples disclosed herein may include the reservoir parameter including at least one selected from a group of saturation, pore pressure, compaction, density, temperature, fluid movement, heat front, and porosity. Examples disclosed herein may also include at least one of the baseline seismic measurements and the monitor seismic measurements including at least one selected from a group consisting of vertical seismic profile measurements and crosswell seismic measurements

As discussed above, examples disclosed herein relate to a non-transitory computer-readable storage medium including a plurality of instructions for analyzing a reservoir parameter, the plurality of instructions including functionality to obtain baseline borehole seismic (BHS) measurements and monitor BHS measurements, calculate a baseline velocity model from the baseline BHS measurements, calculate a monitor velocity model from the monitor BHS measurements, and determine a model change in the reservoir parameter by comparing the baseline velocity model and the monitor velocity model.

Other examples disclosed herein may include instructions including functionality to calculate at least one selected from a group consisting of the baseline velocity model and the monitor velocity model using a full waveform inversion method.

Further, examples disclosed herein may include instructions including functionality to calculate a baseline image by performing a baseline migration using the baseline seismic data and the baseline velocity model, calculate a monitor image by performing a baseline migration using the baseline seismic data and the baseline velocity model, and determine an image change in the reservoir parameter by comparing the baseline image and the monitor image.

Examples disclosed herein may include instructions including functionality to update a reservoir model based on at least one selected from a group consisting of the model change and the image change.

Additionally, examples disclosed herein may include instructions including functionality to generate, by simulating the reservoir model, a first plurality of reservoir properties corresponding to a first time and a second plurality of reservoir properties corresponding to a second time, calculate a first plurality of BHS simulated values from the first plurality of reservoir properties, calculate a second plurality of BHS simulated values from the second plurality of reservoir properties, execute a first comparison of the first plurality of BHS simulated values and the second plurality of BHS simulated values, execute a second comparison of the first plurality of BHS measurements and the second plurality of BHS measurements, calculate a misfit value from the first comparison and second comparison, and update, in response to the misfit value exceeding a threshold, the reservoir model.

Although only a few example examples have been described in detail above, those skilled in the art will readily appreciate that many modifications are possible in the example examples without materially departing from this invention. Accordingly, all such modifications are intended to be included within the scope of this disclosure as defined in the following claims. Moreover, examples disclosed herein may be practiced in the absence of any element which is not specifically disclosed.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for analyzing a reservoir parameter, the method comprising:
obtaining baseline borehole seismic (BHS) measurements and monitor BHS measurements;
calculating a baseline velocity model from the baseline BHS measurements;
calculating a monitor velocity model from the monitor BHS measurements; and
determining a model change in the reservoir parameter by comparing the baseline velocity model and the monitor velocity model.

2. The method of claim 1, wherein at least one of the baseline velocity model or the monitor velocity model is calculated using a full waveform inversion method.

3. The method of claim 1, further comprising:
calculating a baseline image by performing a baseline migration using the baseline seismic data and the baseline velocity model;
calculating a monitor image by performing a baseline migration using the baseline seismic data and the baseline velocity model; and
determining an image change in the reservoir parameter by comparing the baseline image and the monitor image.

4. The method of claim 3, wherein the baseline migration and the monitor migration comprise at least one of a time migration or a depth migration.

5. The method of claim 3, further comprising:
updating a reservoir model based on at least one of the model change or the image change;
generating, by simulating the reservoir model, a first plurality of reservoir properties corresponding to a first time and a second plurality of reservoir properties corresponding to a second time;
calculating a first plurality of BHS simulated values from the first plurality of reservoir properties;
calculating a second plurality of BHS simulated values from the second plurality of reservoir properties;
executing a first comparison of the first plurality of BHS simulated values and the second plurality of BHS simulated values;
executing a second comparison of the first plurality of BHS measurements and the second plurality of BHS measurements;
calculating a misfit value from the first comparison and second comparison; and
updating, in response to the misfit value exceeding a threshold, the reservoir model.

6. The method of claim 3, wherein the reservoir parameter comprises at least one selected from a group consisting of saturation, pore pressure, compaction, density, temperature, fluid movement, heat front, and porosity.

7. A system for analyzing a reservoir parameter, the system comprising:
a computer processor;
a storage unit configured to store baseline borehole seismic (BHS) measurements and monitor BHS measurements;
a velocity builder executable by the computer processor and configured to:
calculate a baseline velocity model from the baseline BHS measurements; and
calculate a monitor velocity model from monitor BHS measurements; and
a velocity analyzer executable by the computer processor and configured to:
determine a model change in the reservoir parameter by comparing the baseline velocity model and the monitor velocity model.

8. The system of claim 7, wherein the velocity builder is further configured to calculate at least one selected from a group consisting of the baseline velocity model and the monitor velocity model by performing a full waveform inversion method.

9. The system of claim 7, further comprising:
an imaging engine executable by the computer processor and configured to:
calculate a baseline image from the baseline velocity model;
calculate a monitor image from the monitor velocity model; and
an image analyzer executable by the computer processor and configured to:
determine an image change in the reservoir parameter by comparing the baseline image and the monitor image.

10. The system of claim 9, wherein the imaging engine is further configured to at least one of:
calculate the baseline image by performing a baseline migration using the baseline seismic data and the baseline velocity model; and
calculate the monitor image by performing a monitor migration using the monitor seismic data and the monitor velocity model.

11. The system of claim 10, wherein the baseline migration and the monitor migration comprise at least one of a time migration or a depth migration.

12. The system of claim 10, further comprising:
an analysis engine configured to update a reservoir model based on at least one selected from a group consisting of the model change and the image change.

13. The system of claim 9, wherein the reservoir parameter comprises at least one selected from a group consisting of saturation, pore pressure, compaction, density, temperature, fluid movement, heat front, and porosity.

14. The system of claim 7, wherein the at least one of the baseline BHS measurements and the monitor BHS measurements comprises at least one selected from a group consisting of vertical seismic profile measurements and crosswell seismic measurements.

15. A method for modeling a reservoir, the method comprising:
obtaining a first plurality of borehole seismic (BHS) measurements of the reservoir corresponding to a first time;
obtaining a second plurality of BHS measurements of the reservoir corresponding to a second time;
obtaining a reservoir model;
generating, by simulating the reservoir model, a first plurality of reservoir properties corresponding to the first time and a second plurality of reservoir properties corresponding to the second time;
calculating a first plurality of BHS simulated values from the first plurality of reservoir properties;
calculating a second plurality of BHS simulated values from the second plurality of reservoir properties;
executing a first comparison of the first plurality of BHS simulated values and the second plurality of BHS simulated values;
executing a second comparison of the baseline BHS measurements and the monitor BHS measurements;
calculating a misfit value from the first comparison and second comparison; and
updating, in response to the misfit value exceeding a threshold, the reservoir model.

16. The method of claim 15, wherein generating the first plurality of BHS simulated values comprises:
generating a plurality of seismic properties by transforming the first plurality of reservoir properties using a petro-elastic model; and
operating a seismic solver on the plurality of seismic properties.

17. The method of claim 16, wherein operating the seismic solver comprises solving a wave equation.

18. The method of claim 16, wherein the plurality of seismic properties comprises at least one selected from a group consisting of velocity and impedance.

19. A method for producing a well, the method comprising:
obtaining baseline borehole seismic (BHS) measurements and monitor BHS measurements;
calculating, by a processor, a baseline velocity model from the baseline BHS measurements;
calculating, by the processor, a monitor velocity model from the monitor BHS measurements;
determining a model change in the reservoir parameter by comparing the baseline velocity model and the monitor velocity model; and
changing a production parameter based on the model change.

20. The method of claim 19, further comprising:
calculating a baseline image by performing a baseline migration using the baseline seismic data and the baseline velocity model;
calculating a monitor image by performing a baseline migration using the baseline seismic data and the baseline velocity model;
determining an image change in the reservoir parameter by comparing the baseline image and the monitor image; and
changing a production parameter based on the image change.
